(19) United States
(12) Patent Application Publication
(10) Pub. No.: US 2004/0267936 A1
(43) Pub. Date: Dec. 30, 2004

(54) System and method for voice/audio input/output and remote telephone conversation

(76) Inventor: Ovadia Sagiv, Ganot (IL)

Correspondence Address: Craig W. Barber, PO Box 16220, Golden, CO, 80402-6004, US

(21) Appl. No.: 10/610,176

(22) Filed: Jun. 30, 2003

(51) Int. Cl. G06F 15/16

(52) U.S. Cl. 709/227; 709/250

(57) ABSTRACT

The present invention teaches that a telephone may be used as an audio/voice output/input device for a personal computer by means of the RJ11 jack of a full duplex voice modem, by means of the application program of the present invention. Such a telephone may be utilized to initiate, receive and carry out VoIP (Voice over Internet Protocol) communications. Such telephone of the invention need not be connected to a conventional wired telephone network (PSTN), and such computer of the invention may operate to provide the VoIP connection in response to DTMF codes received from the telephone, without the necessity of requiring the caller or receiver to interface directly with the computer. The present invention may also be utilized to provide voice/audio input/output to the computer by means of the telephone for purposes other than VoIP.

### FIELD OF THE INVENTION

This invention relates generally to personal computers and specifically to the use of a telephone and modem for voice/audio input/output from a computer, and also specifically to Voice over Internet Protocol software and hardware.

### BACKGROUND OF THE INVENTION

Recent advances in personal computer technology have allowed the use of microphones and speakers for input/output of voice and audio information to and from personal computers. Voice over Internet Protocol (VoIP) is one logical outgrowth of this, though other applications are common. VoIP is a process in which the user's words are picked up by a microphone, which is connected by a minijack to a sound card. The sound card and the appropriate software convert the sounds to Internet protocol messages which are transmitted by the Internet to another personal computer, where the sound card is used to convert the data back into audio speaker output.

In such systems, the normal use of the modem and telephone jacks is only to provide a dial up Internet connection. No conventional telephone is used at the user's end in direct connection with the computer. In fact, even this use is rare in VoIP, as the slow speed of most dial up connections prevents useful VoIP conversation at normal speed. As a result, most VoIP conversations occur between individuals with high speed Internet connections: T1, ISDN, cable, DSL, satellite, wireless, etc.

Another common arrangement is one in which the Internet telephony (VoIP) user is able to call to a regular telephone by means of a PC-to-Phone provider. However, even in these systems the use of the telephone is restricted to the non-PC end of the conversation: the actual VoIP user does not have any means of using a conventional or cordless telephone with their computer in direct connection with the computer.

Various items of prior art may be considered.

U.S. Pat. No. 6,404,764 to Jones et al (Jun. 11, 2002) for VOICE OVER INTERNET PROTOCL TELEPHONE SYSTEM AND METHOD is typical in requiring special equipment in order to provide VoIP to users of PSTN/POTS telephones. Network Premises Gateway 10 is an item of hardware used to provide the desired functionality. There is no teaching that a hookup of the modem/RJ11/telephone may be utilized, nor apparently teaching that the PC may be used in a passive role.

U.S. Pat. No. 6,345,047 issued Feb. 5, 2002 to Regnier for COMPUTER TELEPHONY ADAPTER AND METHOD teaches a system allowing simultaneous use of a single telephone line's bandwidth for both a PSTN telephone call and the use of IP packets. It is otherwise a fairly normal VoIP system, envisioning use of a headset/microphone/speaker system and a hub to connect a telephone to a computer.

U.S. Pat. No. 6,560,660 issued May 6, 2003 to Flanagin for FACILITY COMMUNICATIONS PORT SHARING teaches communication via serial port, monitoring the port to detect when a peripheral device is detected and whether the device is of the appropriate type for use by a software package. It does not relate to use of the modem RJ11 for telephonic voice communications.

U.S. Pat. No. 5,815,682 issued Sep. 29, 1998 to Williams et al for DEVICE INDEPENDENT MODEM INTERFACE teaches a modem interface independent of device, and does not directly deal with VoIP.

U.S. patent Publication No. US 2003/0032393 published Feb. 13, 2003 in the names of Kennedy et al and entitled PERSONAL COMPUTER PHONE PATCH teaches an external adapter box used to connect a telephone to the sound card of the computer.

U.S. patent Publication No. US 2002/0097862 published Jul. 25, 2002 in the name of Shvadron and entitled VODSL TELEPHONY SOLUTION deals with connection of telephone equipment to an adapter communicating digitally with a control device connected to the existing telephone wiring. It does not deal with VoIP.

Yet another device using an external box to connect a telephone to a PC sound card is taught at www.phonebridge.com. Other devices use the USB slot of a computer for such connections, information on the USB devices may be found at, http://www.pcphoneline.com/, http://www.ame-group.com/ipo11.htm, (which device at least utilizes DTMF codes for VoIP via USB), http://www.ipmental.com.tw/en/products-service/taichi3.htm http://www.amegroup.com.au/ipo11.html. http://www.tjnet.com/solutions/usb phone.htm http://www.cuphone.com/, http://www.pcphoneline.com/ and www.1internet-phone.com and www.edcwireless.com. All such devices teach the use of a USB port for audio/voice input and output and thus teach firmly away from use of older types of ports, which are occasionally denigrated as being “legacy ports”. The present invention makes use of one such legacy port. One reason cited for use of the USB port is the availability of power to the telephone: the present invention solves this problem without the USB port. Finally, some devices teach the use of a specialty audio card developed to handle VoIP and drawing power from PC bus slots; information may be found at www.quicknet.com and www.inter-fone.com, and www.edcwireless.com. These other devices do not implicate use of the modem and a standard telephone jack to connect with a standard telephone or cordless telephone.

It would be advantageous to provide a solution which does not require a special card installed in the PC. It would furthermore be advantageous to provide a solution which does not require in all embodiments a special adapter box. It would furthermore be advantageous to avoid external power for the adapter box in embodiments. It would furthermore be advantageous to provide a system in which the computer is not directly accessed by the user when VoIP is desired, that is, to allow a user to simply pick up the telephone and dial. It would furthermore be advantageous to avoid use of the speaker/microphone mini-jack connections to the sound card. Additionally, it would be advantageous to provide a system and method by which simple software installation allows immediate use of the computer's pre-existing capabilities to being use of VoIP. Finally, it would be advantageous to provide a simple system by which an ordinary telephone might be hooked directly to a computer and used to access or control the computer for audio/voice input/output.

### SUMMARY OF THE INVENTION

General Summary

The present invention teaches that a telephone may be used as an audio/voice output/input device for a personal computer by means of the RJ11 jack of a full duplex voice modem, by means of the application program of the present invention. Such a telephone may be utilized to initiate, receive and carry out VoIP (Voice over Internet Protocol) communications. Such telephone of the invention need not be connected to a conventional wired telephone network (PSTN, POTS), and such computer of the invention may operate to provide the VoIP connection in response to DTMF codes received from the telephone, without the necessity of requiring the caller or receiver to interface directly with the computer. The present invention may also be utilized to provide voice/audio input/output to the computer by means of the telephone for purposes other than VoIP.

The advantage of use of a telephone is that the telephone is a customary and well known human interface device, unlike the complexities of utilizing many types of VoIP interface. A cordless telephone in particular is advantageous in terms of built-in capabilities, and in terms of being physically free of the location in which the PC is located: the PC may be in a home office while the cordless telephone “lives” in the personal quarters of a home. Elimination of headsets, speakers, and microphones is a clear advantage as well. Finally, the use of an ordinary telephone saves money in terms of equipment purchase: software only solutions are notably less expensive than hardware implementations.

Summary in Reference to Claims

It is therefore a first aspect, advantage, objective and embodiment of the present invention to provide a device (a computer and telephone system) comprising: a personal computer having an operating system; a full duplex voice modem having a standard telephone jack, such telephone and computer electrically connected by a standard telephone cable plugged into the standard telephone jack; an application program, the application program having a first module able to provide audio input and output between the computer and the telephone by means of the full duplex voice modem, standard telephone cable and standard telephone jack.

It is yet another aspect, advantage, objective and embodiment of the present invention to provide a device wherein the standard telephone jack further comprises an RJ11 jack.

It is yet another aspect, advantage, objective and embodiment of the present invention to provide a device wherein such telephone has an independent power supply.

It is yet another aspect, advantage, objective and embodiment of the present invention to provide a device wherein the application program further comprises a second module able to process DTMF codes generated by such telephone. It is yet another aspect, advantage, objective and embodiment of the present invention to provide a device wherein such computer further comprises: an Internet connection; and wherein the application program further comprises a third module able to process and generate Internet Protocols for communication.

It is yet another aspect, advantage, objective and embodiment of the present invention to provide a device wherein the application program further comprises a fourth module able to monitor the full duplex voice modem and to respond to receipt of DTMF tones from such telephone by initiating Voice over Internet Protocol.

It is yet another aspect, advantage, objective and embodiment of the present invention to provide a device wherein the application program further comprises a fifth module able to generate Voice over Internet Protocol message packets in response to voice communication from such telephone.

It is yet another aspect, advantage, objective and embodiment of the present invention to provide a device wherein the application program further comprises a sixth module able to process Voice over Internet Protocol message packets in and send audio communication received therefrom to such telephone.

It is yet another aspect, advantage, objective and embodiment of the present invention to provide a device wherein the application program further comprises a seventh module able to generate an audio ring-type signal upon receipt of a remote request to begin Voice over Internet Protocol communication.

It is yet another aspect, advantage, objective and embodiment of the present invention to provide a device wherein the application program further comprises an eighth module able to generate one prompt selected from the group consisting of call status prompts, caller identification prompts, call recording prompts, recording playback prompts, voice mail prompts.

It is yet another aspect, advantage, embodiment and objective to provide a device wherein the application program further comprises a module able to manage voice messages.

It is yet another aspect, advantage, objective and embodiment of the present invention to provide a device further comprising: a selector module having a connection to a wired telephone network (PSTN), such telephone being operatively connected to the modem via the selector module, the selector module having a switch having a first position in which DTMF codes generated by such telephone are directed to the full duplex voice modem and a second position in which DTMF codes generated by such telephone are directed to the wired telephone network.

It is yet another aspect, advantage, objective and embodiment of the present invention to provide a device further comprising: a power module having a connection to a source of power, such telephone being operatively connected to the modem via the power module.

It is yet another aspect, advantage, objective and embodiment of the present invention to provide a device wherein the Internet connection further comprises one member selected from the group consisting of: a second modem operatively connected to a telephone network, an ISDN connection, a cable connection, a DSL connection, a wireless connection, a T1 line, and combinations thereof.

It is yet another aspect, advantage, objective and embodiment of the present invention to provide a method of audio/voice input and output for a personal computer having an operating system, and having an Internet connection, and having a full duplex modem, the modem having a standard telephone jack, the method comprising the steps of: operatively connecting a telephone to the personal computer by means of such standard telephone jack; providing an application program; monitoring such modem by means of the application program; receiving input from the telephone into such computer by means of the application program.

It is yet another aspect, advantage, objective and embodiment of the present invention to provide a method further comprising: sending audio output to the telephone via such modem by means of such application program.

It is yet another aspect, advantage, objective and embodiment of the present invention to provide a method further comprising: processing DTMF codes generated by the telephone by means of the application program.

It is yet another aspect, advantage, objective and embodiment of the present invention to provide a method further comprising: responding to the DTMF codes by initiating Voice over Internet Protocols.

It is yet another aspect, advantage, objective and embodiment of the present invention to provide a method further comprising: generating DTMF codes in the application program and sending them to the telephone via such modem.

It is yet another aspect, advantage, objective and embodiment of the present invention to provide a method further comprising: processing Voice over Internet Protocol message packets; and sending audio communication received therefrom to the telephone.

### BRIEF DESCRIPTION OF THE DRAWINGS

FIG. 1 is a block diagram of the first embodiment of the present invention, used to connect two similarly equipped systems, showing in enlargement standard telephone jacks.

FIG. 2 is a block diagram of the first embodiment of the present invention, a second embodiment of the present invention (in which the system and method are used to connect an equipped location with a PSTN/POTS telephone terminal by means of a PC-to-telephone provider), and a third embodiment of the present invention having a selector interface (in which the system and method connect to either a PSTN/POTS network or the Internet, selectively).

FIG. 3 is a block diagram showing a fourth embodiment of the invention in which a power module is used to allow the system to be used with a non-cordless telephone of traditional manufacture to the Internet for VoIP use with other systems equipped with the first embodiment of the invention.

FIG. 4 is a block diagram showing a fifth embodiment of the invention in which two conventional telephones are connected by means of VoIP using two power modules.

FIG. 5 and FIG. 6 are combinational flow-charts/activity-diagrams showing a sixth method embodiment of the present invention, divided up between an initiator, a receptor, and the application program of the previous embodiments.

FIG. 7 is a block diagram of the first embodiment of the invention, showing details of the computer and telephone connection system.

FIG. 8 is a block diagram of the selector interface embodiment of the invention.

FIG. 9 is a block diagram of the power interface embodiment of the invention.

### DETAILED DESCRIPTION

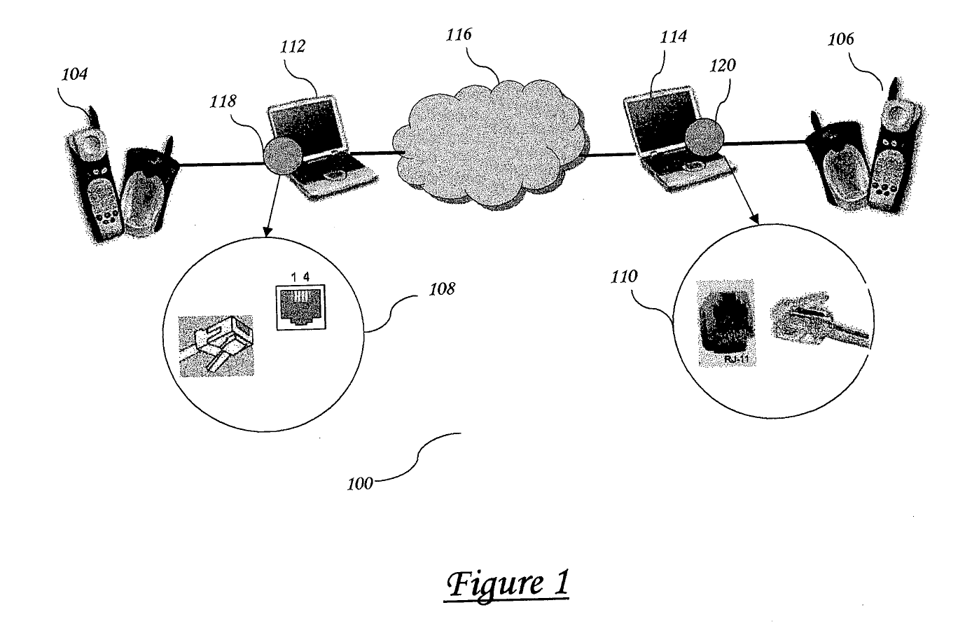

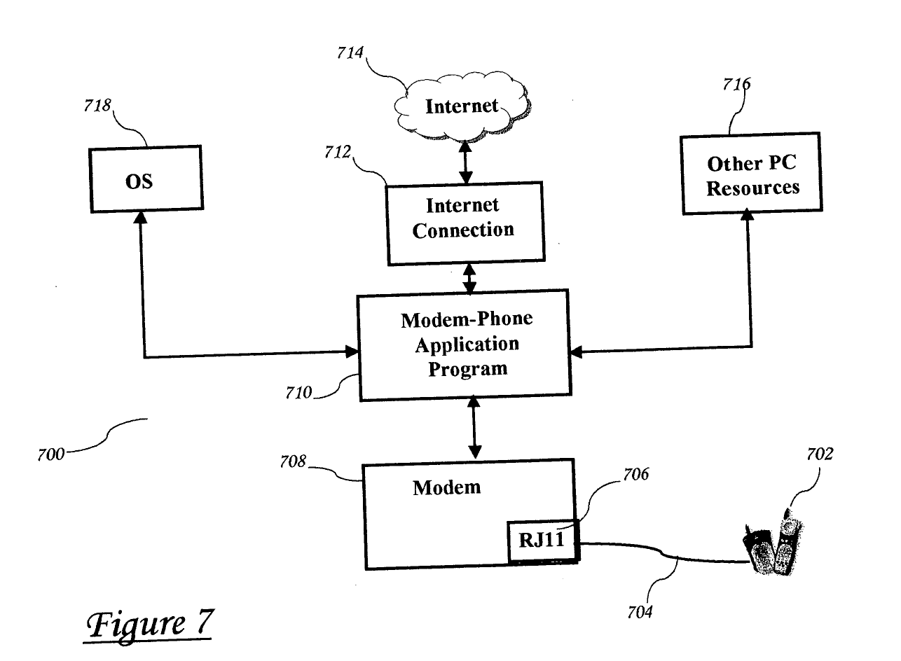

FIG. 1 is a block diagram of one example of the first embodiment of the present invention, used to connect two similarly equipped systems. FIG. 7 is a block diagram of the first embodiment of the invention, showing details of the computer and telephone connection system. Used in a VoIP system to provide convenient telephone service, systems 100 connect standard cordless telephones 104 and 106. Standard telephone jacks 108 and 110 are used to physically connect telephones 104, 106 to modems 118, 120. Computers 112, 114 are thus connected to the telephones through modems 118, 120. Finally, public Internet 116 or equivalent network connects computers 112 and 114. In order to render operative the connection of telephones 104, 106 to modems 118, 120 additional structure is required. As shown in FIG. 7, invention 700 has cordless telephone 702 is physically connected by means of standard telephone cable 704 to standard telephone jack 706, depicted as an RJ11 jack. In the presently preferred embodiment and best mode presently contemplated for carrying out the invention, standard telephone jack 706 is an RJ11, commonly used in all computer modems such as modem 708.

The operative connection of telephone to computer is not established merely by physical and electrical connection. As shown in FIG. 7, Modem-Telephone Control Application Program 710 must monitor the communication port opened up at modem 708 for signals to and from telephone 702. In particular modem-phone application program 710 of the preferred embodiment has at least a module able to provide audio input and output (including voice) from the computer to the telephone and vice-versa by means of the full duplex modem. In support of this, there may be modules able to process DTMF codes (and other standard telephone signals such as “flash”, “off-hook”, “call waiting”, “caller ID” data, etc), a module able to process and generate Internet Protocols for Internet communication, a module able to monitor the full duplex voice modem (including the communications port opened therethrough) and to respond to receipt of DTMF tones from such telephone by initiating Voice over Internet Protocol communications, a module able to generate Voice over Internet Protocol message packets in response to voice communications from such telephone, a module able to process VoIP message packets in and send audio communications received therefrom to such telephone, a module able to generate an audio ring-type signal upon receipt of a remote request to being VoIP communication, a module able to generate other prompts, such as pre-recorded messages or concurrently recorded messages such as call status prompts, caller identification prompts, call recording prompts, recording playback prompts, voice mail prompts, and so on.

Another module may advantageously provide management of voice mail messages: playback, recording, deletion, etc.

These modules may be advantageously implemented as software modules within the application program, or as separate entities such as “plug ins” which cooperate with other software entities such as web browsers, operating systems, word processors and so on. The modules may be implemented, as in the presently preferred embodiment, as a strictly client side service, or they may be implemented with a server side as well. Choice of programming environment is subject to alternative embodiments as well.

In particular, it will be understood that the preferred embodiment and best mode now contemplated comprise an application program which is software and separate from the operating system. However, in a particular alternative embodiment which falls within the scope of the words “application program” as used herein, an application program may be incorporated into the operating system. In another particular alternative embodiment which falls within the scope of the words “application program” as used herein, the application program may be incorporated into such media as ROM, EPROM, hardware, etc, either in the modem or the computer itself.

Internet connection 714 may advantageously be a broadband connection of any of several well known types: cable, DSL, T1, ISDN, satellite, wireless, etc. Internet connection 714 may also be a dial up connection, with two important notes.

The first item is that dial up connections tend to be fairly slow, for example, 56 Kbaud and/or even slower. At such speeds, VoIP quality is degraded.

The second issue is that when a communication port is open under the control of the application program (from the modem connected to the telephone) then it becomes difficult or impossible to establish a dial up Internet connection through the same modem. Thus, for uses seeking to use the invention and dial-up access at the same time, a second modem becomes preferable. However, installation of a dial up modem is still relatively easy compared to the task of installing specialty cards such as those discussed in the prior art.

The present invention may also be used to provide audio/voice input/output to and from other PC resources 716. For example, some people find use of a microphone, speaker, or headset quite inconvenient in comparison to a telephone. Thus any use of the computer for which microphone, speaker or headset may be employed, may instead use the present invention. One example is that of voice recognition software used to transcribe vocal words to text in the computer. Another example is control of the operating system 718, which may be voice controlled for the benefit of handicapped users. For some individuals, voice control of the OS by means of a telephone handset may be more convenient than control by means of a microphone.

Table 1 shows operations of the present invention in more detail, for embodiments/uses in VoIP communications.

TABLE 1

| Initiator Side [I] | | | Receptor End [R] | |
|---|---|---|---|---|
| Cordless Phone | Computer | Connection | Computer | Phone |
| [I] presses | Initiate Calling | [symbol] Internet → | | |
| Power-On → | program | or | | |
| | Check if connected | Network | | |
| | → | | | |
| | N? | ↓ | | |
| | [symbol] Prompt: “no | ↓ | | |
| | connection” | | | |
| | Y? | | | |
| | [symbol] Prompt: “press | | | |
| | “*” to dial | | | |
| | PC-to-PC or press | | | |
| | “9” to dial | | | |
| | PC-to-Phone” | | | |
| “9” pressed On → | [symbol] Produce Dial | | Not needed | Any |
| | Tone | | | |
| [I] dials Receptor's | DTMF detection | | Not needed | Any |
| ID/Tel# → | Registered to | | | |
| | PC-to-Phone | | | |
| | provider? | | | |
| | N? | | | |
| | [symbol] Prompt: “not | | | |
| | registered | | | |
| | PC-to-Phone | | | |
| | account. press “*” | | | |
| | to dial PC-to-PC” | | | |
| | Y? | | | |
| | Initiate provider's | | | |
| | calling program | | | |
| | VoIP Call → | | | |
| | [symbol] Send Ring Tone → | | | Conduct the call |
| | Conduct the | | | |
| | call or follow | | | |
| | provider's | | | |
| | instructions | | | |
| “*” pressed On → | [symbol] Produce Dial | [symbol] Internet → | | |
| | Tone | or | | |
| | | Network | | |
| | | ↓ | | |
| | | ↓ | | |
| [I] dials Receptor's | DTMF detection | | | |
| ID# → | Check if [R]'s IP | | | |
| | address listed | | | |
| | N? | | | |
| | [symbol] Prompt: | | | |
| | “Receptor not | | | |
| | listed” | → → | | |
| | Y? | → | | |
| | Initiate VoIP Call | | → [R] online and | |
| | request → | | ready | |
| | [symbol] If not answered | | → Initiate [R] Call | |
| | Prompt: “Receptor | | program | |
| | not ready” | → → | | |
| | | → | [symbol] Send | → Ringing |
| | | | confirmation ID | |
| | [R] connected and | | → → | |
| | identified [symbol] | | → | |
| | [symbol] Send Ring Tone → | | | |
| | | | Prompt: “[I] is | [symbol] Power-On |
| | | | calling. press “1” | pressed |
| | | | to accept or press | |
| | | | “2” to reject or | |
| | | | hang up” → | |
| | [symbol] Prompt: “Start | [symbol] [symbol] | [symbol] [symbol] | [symbol] [R] presses “1” |
| | conversation” | [symbol] | [symbol] | |
| Conduct the | | [symbol] → | | [symbol] → Conduct |
| call [symbol] → | | | | the call |
| | [symbol] Prompt: “Call | [symbol] [symbol] | [symbol] [symbol] | [symbol] [R] presses “2” |
| | rejected” | [symbol] | [symbol] | or hangs up |

Note 1:
All prompts are looped several finite times and are representative of a possible wording message.

As shown in Table 1, with the invention already installed on the computer and the cordless telephone plugged into the modem via standard telephone jacks, the user need not directly access the computer at all in order to place a telephone call. As an example, the cordless telephone may in one room while the computer is on in another room, awaiting receipt of either DTMF or “power on”, “flash” codes or others from the telephone. The computer may even be in a “sleep” state provided appropriate modules exist to allow receipt of DTMF or “power on” or other codes to activate the computer and bring the telephone-modem control application program to operation. The “calling” module of the application program may be activated by this signal from the telephone. If the “VoIP Initiation” module determines that there is no Internet connection, it may prompt the user to alert them to this fact, while if in fact there is an operative connection to the Internet, the application program may direct the user to begin dialing. In alternative embodiments, a default dialing status may be utilized instead of a prompt.

In the best mode now contemplated for carrying out the invention, a “9” or “*” by the user will indicate whether a PC-to-PC call is desired, or if a PC-to-telephone-via-provider connection is desired. Appropriate modules of the application program will thereafter detect DTMF codes, initiate VoIP service to either another PC or a PC-to-Phone service provider, verify that the called system is available to accept the connection, verify ID, and conduct the actual voice communication desired. In the preferred embodiment, these operations on the part of the application program are automatic responses to the input provided by the user. Further prompts to elicit such input include prompts indicating a lack of registration to the PC-to-Telephone service provider, indicate an unknown callee (receptor/receiver), a receptor not presently able to receive a call, a prompt that voice communication has been established, that the receptor has not answered the ring-type prompt, and so on.

When used in receiving mode, the application program may provide prompts that a call is waiting, provide caller ID, provide prompts to accept or reject the call, etc.

One important prompt not yet detailed is the ring-type signal.

In a conventional telephone hooked to POTS/PSTN type service, a 90 Volt AC signal or other relatively high power signal is used to initiate the ring signal and thus alert the user to the incoming call. However, few if any modems are able to generate such a signal. Thus, it becomes necessary to provide some other method of providing a ring-type signal when one wants to receive a call and not only to initiate one.

The use of the cordless telephone greatly eases this requirement of call reception. Cordless telephones have a battery in the portable handset, and appropriate circuitry such that when the cordless telephone base unit receives a ring signal, the telephone may easily cause a ring-type signal in the handset even when it is apart from the base unit. Hence, when the cordless is apart and its power is switched on, it is ready to accept a loud ring prompt from the computer application program via the base unit, exactly as it receives all other voice prompts. Power consumption of the cordless battery is not a problem because they are designed and guaranteed for long hours with power on and idle. It will be appreciated that any telephone which has an independent power supply may also have the capability to generate a loud ring signal without receiving an elevated voltage which modems are generally unable to provide. For example, some office telephones now have AC power adapters and/or internal batteries even though they are not cordless type telephones. Such telephones may also be used with the present invention.

In addition, other types of telephones may also be used, in a manner to be discussed in reference to other alternative embodiments which provide power by another means.

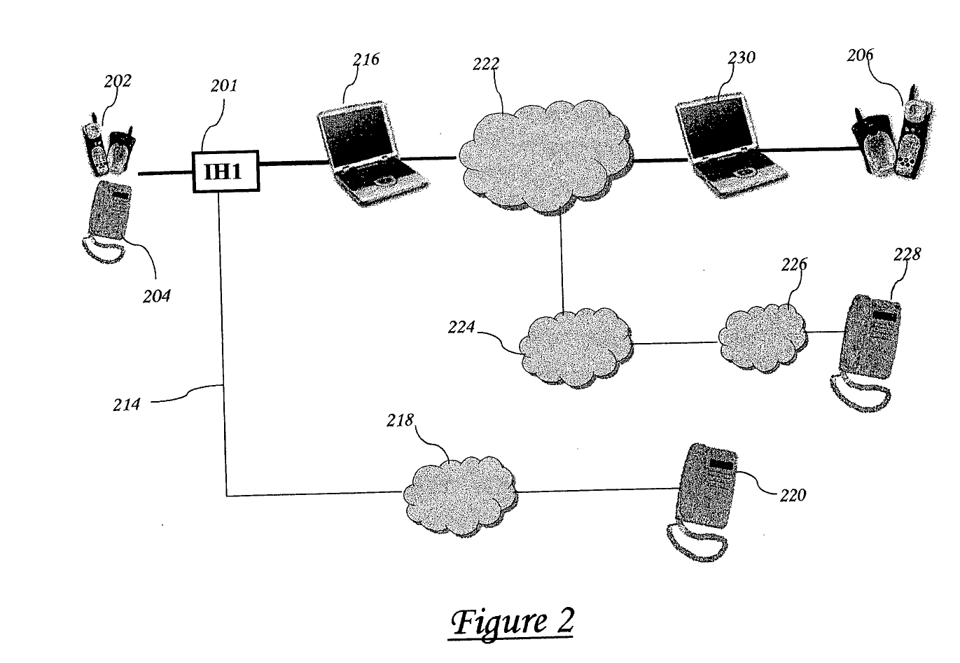

FIG. 2 is a block diagram of the first embodiment of the present invention, a second embodiment of the present invention (in which the system and method are used to connect an equipped location with a PSTN/POTS telephone terminal by means of a PC-to-telephone provider), and a third embodiment of the present invention having a selector interface (in which the system and method connect to either a PSTN/POTS network or the Internet, selectively). Telephones 202, 204, 206 are connected using the invention as discussed herein, either in the first or second embodiments, or in other alternative embodiments. IH1 is a selector module 201 having a connection 214 to a wired telephone network 218. Telephones 202, 204 are operatively connected to the modem of PC 216 via selector module 201, but are also connected to POTS/PSTN therethrough. PC 216 is connected to the Internet 222 and thus to either another computer having the invention 230 or a PC-to-Phone provider 224 and thus to PSTN 226 and telephone 228. In use, selector module 201 may be accessed to provide VoIP to telephone 206 by means of a PC-to-PC call, or to provide VoIP (one ended only) to telephone 228 via PC-to-Telephone service as discussed previously, or it may provide NON-VoIP service to telephone 220 by means of connection 214 to PSTN 218.

Selector module 201 may have a switch having first and second positions, in the first position DTMF codes generated by the telephone are directed to the full duplex voice modem and handled as previously discussed, while in the second position, DTMF codes generated by such telephone are directed to the wired telephone network 218 and other use of the present invention is not implicated.

Switch does not necessarily refer to a hardware switch hand operated by a user. The switch system may be controlled by the application program, by DTMF codes generated by the telephone, or it may be automatic. For example, in one alternative embodiment, the switch may select the appropriate route for telephone service based upon the callee telephone number entered by the user.

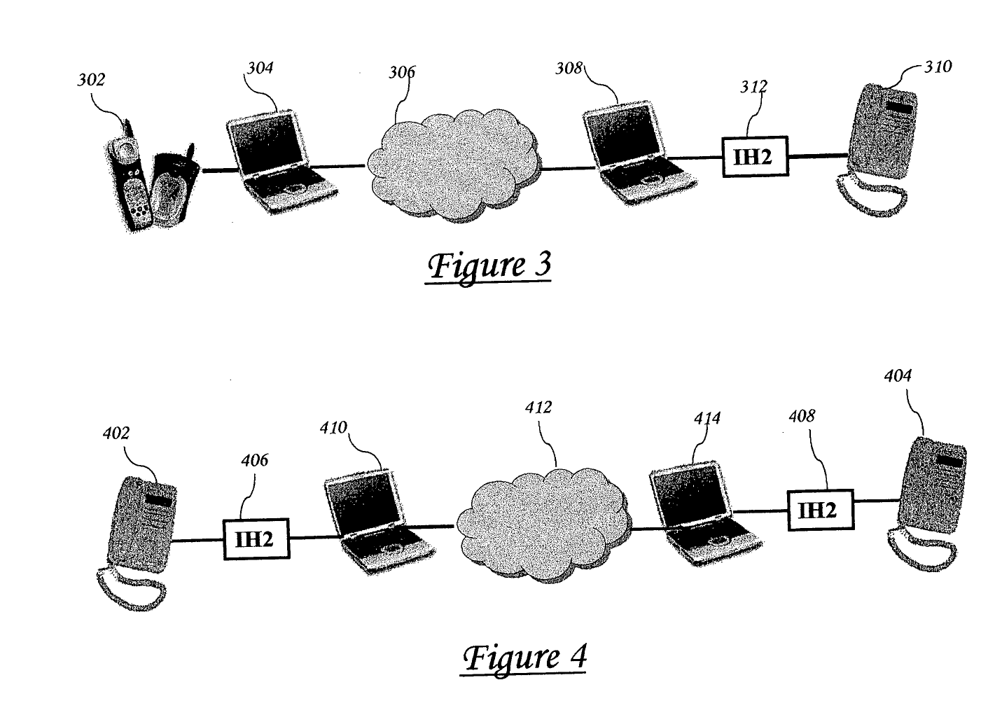

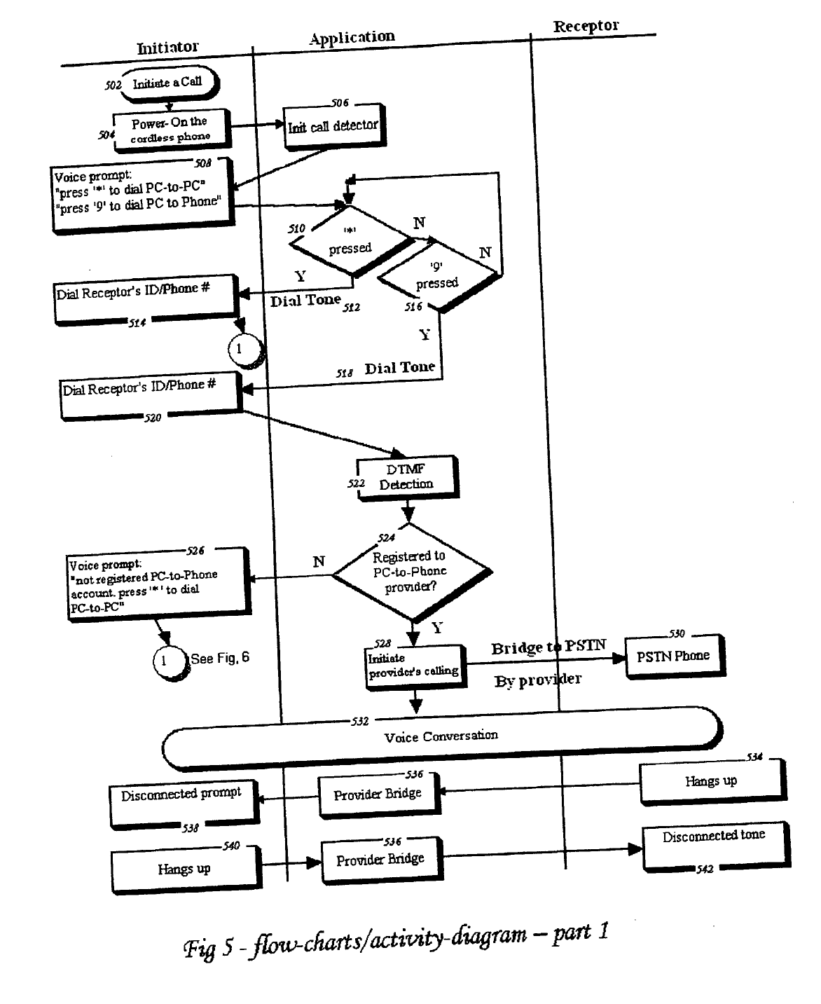

FIG. 3 is a block diagram showing a fourth embodiment of the invention in which a power module is used to allow the system to be used with a non-cordless telephone of traditional manufacture to the Internet for VoIP use with other systems equipped with the first embodiment of the invention. Telephone 302, PC 304, Internet 306, PC 308 are as discussed with regard to other embodiments. However, telephone 310 is of conventional design, and requires a relatively high AC power/voltage signal in order to generate a ring signal and DC power/voltage for operation. Thus power module 312 is utilized. Power module 312 has a connection to a source of power, and telephone 310 is operatively connected to the modem via power module 312. When a ring signal is required, the application program will be able to generate the required power (not available through the hardware of a modem) from power module 312. FIG. 4 is a block diagram showing a fifth embodiment of the invention in which two conventional telephones 402, 404 are connected by means of VoIP using two power modules 406, 408, which is otherwise similar to the previously discussed embodiments.

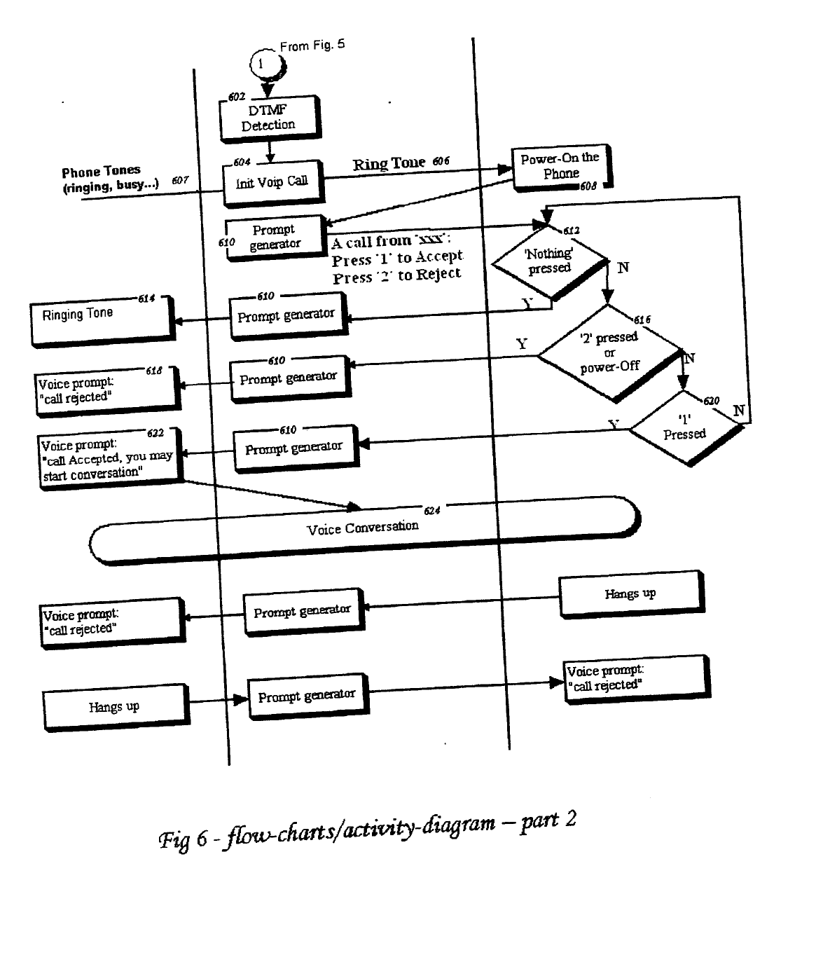

FIG. 5 and FIG. 6 are combinational flow-charts/activity-diagrams showing a sixth method embodiment of the present invention, divided up between an initiator, a receptor, and the application program of the previous embodiments. As noted previously, in the best mode now contemplated, all software is resident in the computer(s), without need for any server involvement beyond normal VoIP packet handling.

As shown in FIG. 5, the method aspect of the present invention involves three domains: an initiator, the application program resident in the computer, and a receptor. Boxes on the flow chart/activity diagram which fall under a given heading are carried out in that domain. Of course, the “receptor” domain may itself be a second instantiation of the present invention, with it's own application program, etc.

Step 502 depicts the initiation of a call. At step 504, the user normally pushes the “power” or “on” or “talk” button of a cordless telephone in order to power on the telephone.

At this point, the resident application program's “call initiation detector” module, which monitors the open communication ports of the telephone through the modem and the one to the Internet, automatically detects at step 506 the fact that a call has been initiated. It immediately checks existence or establishes Internet connection. If no connection to the Internet exists it prompts the caller accordingly as outlined in Table 1. Alternatively—It may thereafter return a voice prompt to the user at step 508 and instruct the caller to select which type of call he wants to conduct: either PC-to-PC (press * in for example) or PC-to-Phone (Press 9 in for example).

At this point, the application program detects the caller's selection and checks at step 510 whether the caller pressed “*”. If the response is yes—it sends a dial tone to the caller at step 512, then the caller at step 514 can now dial the ID of the receptor# (such as his code# or phone#) in order to make a PC-to-PC call as described in FIG. 6. Otherwise, it goes and checks at step 516 whether the caller pressed “9”. If this response is a yes, then it sends a dial tone to the caller at step 518, then the caller at step 520 can now dial the ID of the receptor# (such as his code# or phone#) in order to make a PC-to-Phone call as described in steps 522 and on. If “9“is not pressed the application program loops again to step 510 until the caller selects * or 9 or abandons the call.

At step 522 the application program detects the DTMF codes dialed and thereafter checks at step 524 if the caller is registered to a PC-to-Phone Provider or whether PC-to-Phone call can take place. If not, it prompts at step 526 the caller accordingly and suggests to call using PC-to-PC connection. However, if the response is yes then the application program initiates at step 528 the Provider's calling sequence, who in turn dials the destination PSTN phone number in step 530 and a regular voice conversation takes place between the two parties at step 532. When the destination hangs up at step 534 the provider's bridge at the application program, step 536, generates and sends a disconnected prompt, step 538, to the caller.

Termination is the reverse. When the caller hangs up at step 540 the provider's bridge at the application program, step 536, generates and sends a disconnected tone to the provider's PSTN bridge who in turn generates in step 542 a normal PSTN disconnected tone.

As shown in FIG. 6, part 2 of the flow chart/activity diagram deals with the PC-to-PC part of the invention after getting there from step 514 described above. Of course, the “receptor” domain itself has to be equipped with a second instantiation of the present invention, with it's own application program, etc.

At step 602 the application program detects the DTMF codes dialed and thereafter generates at step 604 the VoIP sequence of the caller's application program and sends to the receptor's side a ring tone message, step 606. The receptor's application program detects the ring tone message and sends to the receptor's cordless phone an actual ring tone, which when picked up or after pressing the power on at step 608, the receptor can accept or reject the call following a proper prompt message generated at step 610 by its application program, to press a key #1 to accept the call or to press a key #2 to reject the call. Naturally, the caller side keeps hearing if it is ringing (or busy etc . . . ) on the other side, step 607.

As long as nothing is pressed, step 614, the caller continues to hear a ringing tone by step 614, from his side of the application program at step 610. If receptor pressed key #2 or hanged up at step 616, both application programs communicate and at step 610 the caller's application program prompts him that his call was rejected, step 618. If receptor pressed key #1 at step 620, both application programs communicate and at step 610 the caller's application program prompts him that his call can proceed, step 622 and a regular voice conversation takes place between the two parties at step 624. Termination of the call by each side and prompts are same as described in the explanations of FIG. 5.

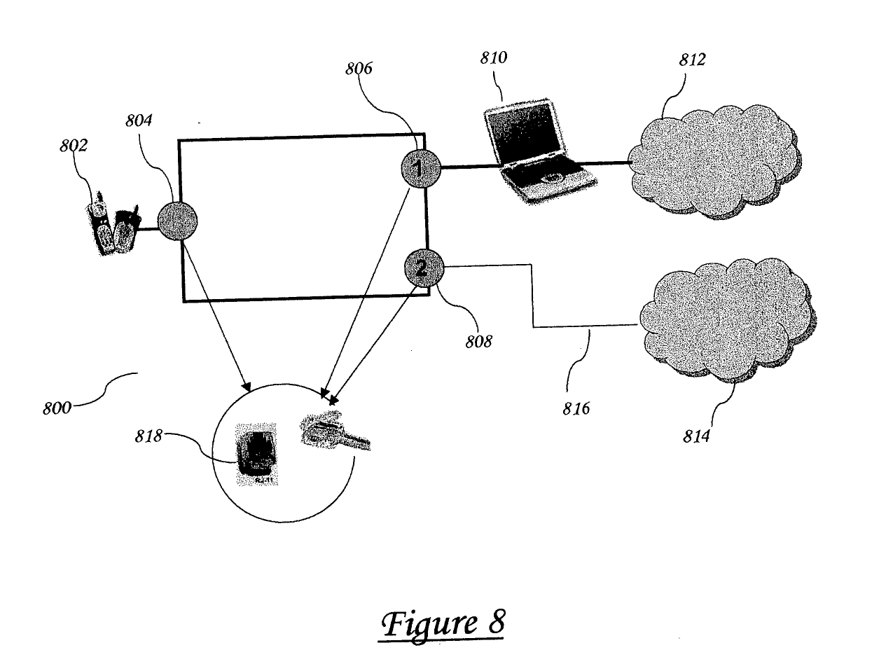

FIG. 8 is a block diagram of the selector interface embodiment of the invention. Device 800 has telephone 802 connected by means of RJ11 connections 804, 806, 808 (expanded view 818) to both personal computer 810 and thus public Internet 812, and also to PSTN 814 by means of telephone line 816. It will be appreciated that a switching mechanism (not shown) may be incorporated so as to allow telephone 802 to be used with either the PSTN network or the Internet. As stated, such switch may be mechanical, electronic, manual, automated, etc.

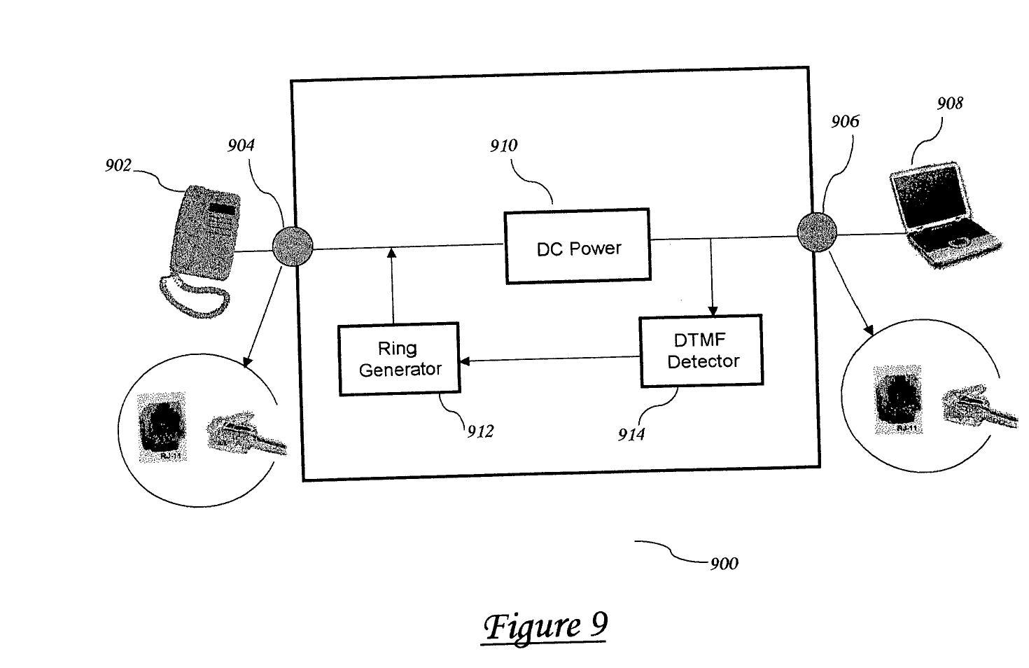

FIG. 9 is a block diagram of the power interface module embodiment of the invention. System 900 has telephone 902 connected to the power interface module via RJ11 904. The module in turn is connected to a personal computer 908 via RJ11 906. Not shown is that personal computer 908 may be used to communicate with the Internet and thus for VoIP. Internal to the power module, DC Power Supply 910 connected to a source of power (External or Battery, not shown) is used to provide DC power to telephone 902 and to DTMF detector 914 and to Ring generator 912. Ring generator 912 is used for generation of a 90 VAC or other relatively high power signal when DTMF detector 914 sends it a command to ring the receptor telephone 902. DTMF detector 914 is used to detect DTMF ringing command generated by the application program resident in computer 908. All other DTMF and audio signals sent and received between computer 908 and telephone 902 pass directly through the DC Power Supply 910.

Specific codes and responses have been provided to aid understanding, for example, the use of “*” to indicate a PC-to-PC call and the use of “9“to indicate a PC-to-Telephone call. However, it will be appreciated that wide variety of prompts may be used. Any DTMF tone is suitable for use with the best mode now contemplated for carrying out the invention, as are other signals such as a “flash” signal and so on.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A computer and telephone system comprising:
a personal computer having an operating system;
a full duplex voice modem having a standard telephone jack, such telephone and computer electrically connected by a standard telephone cable plugged into the standard telephone jack;
an application program, the application program having a first module able to provide audio input and output between the computer and the telephone by means of the full duplex voice modem, standard telephone cable and standard telephone jack.

2. The computer and telephone system of claim 1, wherein the standard telephone jack further comprises an RJ11 jack.

3. The computer and telephone system of claim 1, wherein such telephone has its own power supply.

4. The computer and telephone system of claim 1, wherein the application program further comprises a second module able to process DTMF codes generated by such telephone.

5. The computer and telephone system of claim 4, wherein such computer further comprises:
an Internet connection; and
wherein the application program further comprises a third module able to process and generate Internet Protocols for communication.

6. The computer and telephone system of claim 5, wherein the application program further comprises a fourth module able to monitor the full duplex voice modem and to respond to receipt of DTMF tones from such telephone by initiating Voice over Internet Protocol.

7. The computer and telephone system of claim 6, wherein the application program further comprises a fifth module able to generate Voice over Internet Protocol message packets in response to voice communication from such telephone.

8. The computer and telephone system of claim 7, wherein the application program further comprises a sixth module able to process Voice over Internet Protocol message packets in and send audio communication received therefrom to such telephone.

9. The computer and telephone system of claim 8, wherein the application program further comprises a seventh module able to generate an audio ring-type signal upon receipt of a remote request to begin Voice over Internet Protocol communication.

10. The computer and telephone system of claim 9, wherein the application program further comprises an eighth module able to generate one prompt selected from the group consisting of call status prompts, caller identification prompts, call recording prompts, recording playback prompts, voice mail prompts.

11. The computer and telephone system of claim 9, wherein the application program further comprises a ninth module able to manage voice messages.

12. The computer and telephone system of claim 1, further comprising:
a selector module having a connection to a wired telephone network, such telephone being operatively connected to the modem via the selector module, the selector module having a switch having a first position in which DTMF codes generated by such telephone are directed to the full duplex voice modem and a second position in which DTMF codes generated by such telephone are directed to the wired telephone network.

13. The computer and telephone system of claim 1, further comprising:
a power module having a connection to a source of power, such telephone being operatively connected to the modem via the power module.

14. The computer and telephone system of claim 5, wherein the Internet connection further comprises one member selected from the group consisting of: a second modem operatively connected to a telephone network, an ISDN connection, a cable connection, a DSL connection, a wireless connection, a T1 line, and combinations thereof.

15. A method of audio/voice input and output for a personal computer having an operating system, and having an Internet connection, and having a full duplex modem, the modem having a standard telephone jack, the method comprising the steps of:
operatively connecting a telephone to the personal computer by means of such standard telephone jack;
providing an application program;
monitoring such modem by means of the application program;
receiving input from the telephone into such computer by means of the application program.

16. The method of claim 15, further comprising:
sending audio output to the telephone via such modem by means of such application program.

17. The method of claim 15, further comprising:
processing DTMF codes generated by the telephone by means of the application program.

18. The method of claim 16, further comprising:
responding to the DTMF codes by initiating Voice over Internet Protocols.

19. The method of claim 16, further comprising:
generating DTMF codes in the application program and sending them to the telephone via such modem.

20. The method of claim 16, further comprising:
processing Voice over Internet Protocol message packets; and
sending audio communication received therefrom to the telephone.
